(19) United States
(12) Patent Application Publication
(10) Pub. No.: US 2026/0334435 A1
(43) Pub. Date: Oct. 29, 2026

(54) Animal Leading Device; Method for Determining a Distance Between a Point A and a Point B

(71) Applicant: Wilfried Kochannek, Bad Wimpfen (DE)

(72) Inventor: Wilfried Kochannek, Bad Wimpfen (DE)

(21) Appl. No.: 19/099,058

(22) PCT Filed: Aug. 7, 2023
(86) PCT No.: PCT/DE2023/100579

§ 371 Date: Jan. 28, 2025

(30) Foreign Application Priority Data
Aug. 18, 2022 (DE) 102022120882.6

(51) Int. Cl. A01K 27/00; G01B 3/1084

(52) U.S. Cl. CPC A01K 27/004; G01B 3/1084

(57) ABSTRACT

An animal walking device (1) and a method for determining a distance between a point A and a point B are proposed, wherein the animal walking device (1) has at least one leash (3) and at least one attachment device (9) that is arranged on the leash (3) at an attachment point (8) and serves for attaching said leash (3) onto a collar worn by an animal being walked or onto a harness worn by an animal being walked, or wherein the animal walking device has a collar for an animal being walked which is fixedly arranged on the leash, wherein the inventive animal walking device has at least one measuring scale (14), preferably a linear measuring scale (14), whereby the inventive animal walking device (1) can be used, on the one hand, for walking an animal and, on the other, for determining a distance.

### CROSS REFERENCE TO RELATED APPLICATIONS

This application is the U.S. national stage of International Application No. PCT/DE2023/100579, filed on 2023Aug. 7. The international application claims the priority of DE 102022120882.6 filed on 2022Aug. 18; all applications are incorporated by reference herein in their entirety.

### BACKGROUND

The invention is based on an animal walking device according to the preamble of claim 1 and on a method for determining a distance between a point A and a point B according to the preamble of claim 9.

Animal walking devices, in particular dog leashes and cat leashes, have been the state of the art for a long time. The utilisation of such an animal device enables a user to safely walk an animal (e.g. a dog or a cat). In addition to animal walking devices having a fixed length, other animal walking devices including a retractor device (automatic retractor) have meanwhile been known. These leashes, known as retractable or automatic leashes, are characterised in that a user operating the retractable leash may choose to vary the freedom of movement of an animal (e.g. a dog or a cat) being walked. The retractor device serves for winding a leash, which may, in particular, be a ribbon, a strap, or a cable, onto a reel accommodated in a handle housing or for unwinding the latter from said reel.

In addition to the actual task of an animal walking device, namely walking an animal, such animal walking devices have, over time, been equipped with other, additional functionalities. For example, German utility model DE 299 03 782 U1 discloses a dog leash with lighting, German utility model DE 297 05 424 U1 discloses a retractable dog leash including a stun gun, German published application DE 10 2004 034 754 A1 discloses a dog walking device containing a device for dog faeces disposal, and German published application DE 10 2015 012 707 A1 discloses a retractor device for an animal leash including a heatable handle.

Furthermore, German utility model DE 200 16 934 U1 discloses a retractable dog leash that is to be used in areas subjected to mandatory leashing of dogs and in which a multi-coloured design of the leash signals to the user when a maximum leash length specified by a dog owner regulation has been reached.

Disadvantageously, the maximum leash length specified by a dog owner regulation may vary for individual mandatory leashing areas, so that the dog owner needs to swap leashes when switching from one area to another.

Furthermore, US patent U.S. Pat. No. 5,430,952 A discloses a retractable measuring tape which is not suitable for walking an animal, and Korean patent KR 10 2022 0 061 758 A and English patent application GB 2 199 306 A disclose a retractable dog leash which has a measuring tape that functions as a leash, but which, depending on its use, has insufficient measuring accuracy.

### SUMMARY

An animal walking device (1) and a method for determining a distance between a point A and a point B are proposed, wherein the animal walking device (1) has at least one leash (3) and at least one attachment device (9) that is arranged on the leash (3) at an attachment point (8) and serves for attaching said leash (3) onto a collar worn by an animal being walked or onto a harness worn by an animal being walked, or wherein the animal walking device has a collar for an animal being walked which is fixedly arranged on the leash, wherein the inventive animal walking device has at least one measuring scale (14), preferably a linear measuring scale (14), whereby the inventive animal walking device (1) can be used, on the one hand, for walking an animal and, on the other, for determining a distance.

### DETAILED DESCRIPTION

It is therefore an object of the invention to provide an animal walking device that overcomes the disadvantages of the state of the art and to provide a method for determining a distance between a point A and a point B that overcomes the disadvantages of the state of the art.

The inventive animal walking device having the features of claim 1 and the inventive method for determining a distance between a point A and a point B having the features of claim 9 have, in contrast, the advantage that the inventive animal walking device has at least one leash and at least one attachment device that is arranged on the leash at an attachment point and serves for attaching said leash onto a collar worn by an animal being walked or onto a harness worn by an animal being walked, or that the animal walking device has a collar for an animal being walked which is fixedly arranged on the leash, wherein the inventive animal walking device has at least one measuring scale, preferably a linear measuring scale, wherein at least one measuring scale is arranged on the leash and on the attachment device or at least one measuring scale is arranged on the leash and on the collar that is fixedly arranged on the leash, whereby the inventive animal walking device can be used, on the one hand, for walking an animal and, on the other, for determining a distance.

According to an advantageous configuration of the inventive animal walking device, at least one other measuring scale is arranged on the leash and/or on the attachment device, or at least one other measuring scale is arranged on the leash and/or on the collar that is fixedly arranged on the leash.

According to an additional advantageous configuration of the inventive animal walking device, the zero point of the measuring scale is arranged on the leash, on the attachment device, or on the collar that is fixedly arranged on the leash.

According to an additional advantageous configuration of the inventive animal walking device, at least one leash is at least partially a ribbon, at least partially a strap and/or at least partially a cable.

According to an additional advantageous configuration of the inventive animal walking device, the animal walking device has a retractor device for at least one leash. Thus, the inventive animal walking device is a retractable leash which characteristically differs from conventional leashes in that a spring-loaded reel that is preferably accommodated in a handle housing will roll up the leash automatically. Always slightly tensioned, the leash will thus not drag along the ground, regardless of the distance between the animal, e.g. the dog, being walked and the user. The retractable leash is equipped with a brake that makes it possible for the user to limit the free movement of the animal at any time. The brake can be set to permanent stop, whereby the leash is set to a fixed length so that the animal being walked can be kept at a given distance (e.g. at foot).

According to an additional advantageous configuration of the inventive animal walking device, the attachment device is a hook, a spring hook, or an eyelet.

According to an additional advantageous configuration of the inventive animal walking device, at least one measuring scale has a metre measurement unit, an inch measurement unit and/or a foot measurement unit.

According to an additional advantageous configuration of the inventive animal walking device, the animal walking device has at least one pocket calculator, at least one pen holder and/or at least one notepad holder. This has the advantage that measured distances may jointly be used for making calculations and/or may be noted down.

According to an advantageous configuration of the inventive method for determining a distance between a point A and a point B, wherein a measuring scale is used for measuring said distance, wherein an animal walking device is employed for determining a distance, wherein the employed animal walking device has at least one leash and at least one attachment device that is arranged on the leash at an attachment point and serves for attaching the leash onto a collar worn by an animal being walked or onto a harness worn by an animal being walked or wherein it has a collar for an animal being walked which is fixedly arranged on the leash, wherein the inventive animal walking device has at least one measuring scale by means of which a distance may be determined by a user, wherein at least one measuring scale is arranged on the leash and on the attachment device or at least one measuring scale is arranged on the leash and on the collar that is fixedly arranged on the leash, the animal walking device employed for distance determination is at least temporarily attached to the animal being walked.

According to a pertinent advantageous configuration of the inventive method, at the time of distance determination, the measuring scale is positioned at point A by the user and at point B by the animal attached to the animal walking device.

According to a pertinent advantageous configuration of the inventive method, at the time of distance determination, the zero point of the measuring scale is positioned at point A or at point B.

According to an additional advantageous configuration of the inventive method, in a process step prior to the time of distance determination, the user moves towards point A and/or the animal attached to the animal walking device moves towards point B.

According to an additional advantageous configuration of the inventive method, the path to be taken by the user when walking in the direction of point A leads via point B for enabling the positioning of the measuring scale at point B by the animal attached to the animal walking device, and/or the path to be taken by the animal attached to the animal walking device when walking towards point B leads via point A for enabling the positioning of the measuring scale at point A by the user.

According to an additional advantageous configuration of the inventive method, the animal walking device employed is an animal walking device for a dog.

According to an additional advantageous configuration of the inventive method, the animal walking device employed is an animal walking device as claimed in any one of claims 1 to U+00a08.

Further advantages and advantageous configurations of the invention may be found in the following description and in the drawings.

### BRIEF DESCRIPTION OF THE DRAWINGS

Preferred embodiment examples of the object of the invention are represented in the drawings and will be described hereunder in greater detail. In the drawings:

FIG. 1 is a side view of an animal walking device according to the invention,

FIG. 2 is a side view of the handle housing of the inventive animal walking device according to FIG. 1,

FIG. 3 is a detail view of the leash and scroll spring of the inventive animal walking device according to FIG. 1,

FIG. 4 is a side view of the break mechanism of the inventive animal walking device according to FIG. 1, and

FIG. 5 is a portion of a leash of an inventive animal walking device.

### DETAILED DESCRIPTION OF THE PREFERRED EMBODIMENTS

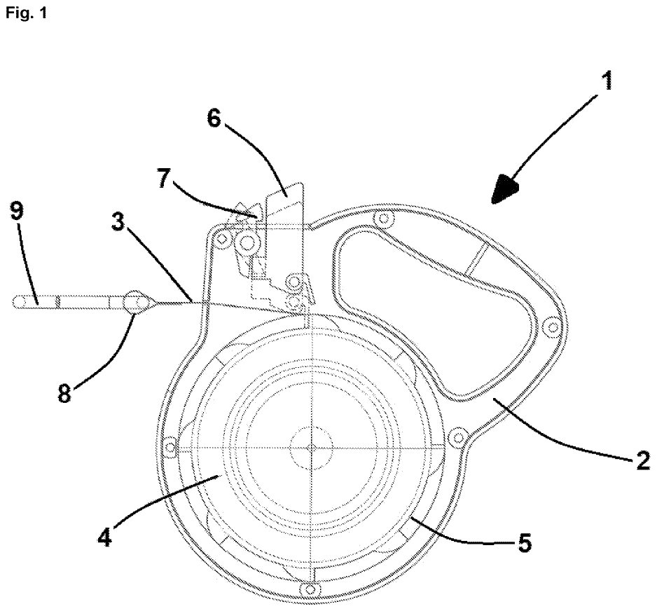

FIG. 1 is a side view of an animal walking device 1 according to the invention.

The inventive animal walking device 1, which is represented in its idle state, is configured as a retractable leash and has a handle housing 2 in which the leash 3 is automatically wound onto a drum 5 by means of a scroll spring 4. By pulling on the leash 3, said leash 3 can be set to a length desired by the non-illustrated user. This causes tensioning of the scroll spring 4 (in a manner similar to that of a clockwork mechanism) and this spring force can be used to wind up the leash 3 again. The functional principle is similar to that when reeling up the power cable of a vacuum cleaner. The length of the leash 3 may be adjusted by a non-illustrated user via a break mechanism which consists, in particular, of a braking knob 6 and a locking knob 7. The leash 3, which may differ in length and may, for example, have lengths of 5 m, 7 m, 10 m, or 20 m, has an attachment point 8 which serves for attaching the leash 3 to a non-illustrated collar or a non-illustrated harness of a non-illustrated animal that is being walked and on which an attachment device 9 in the form of a hook (e.g. a chrome hook) or a spring hook is arranged.

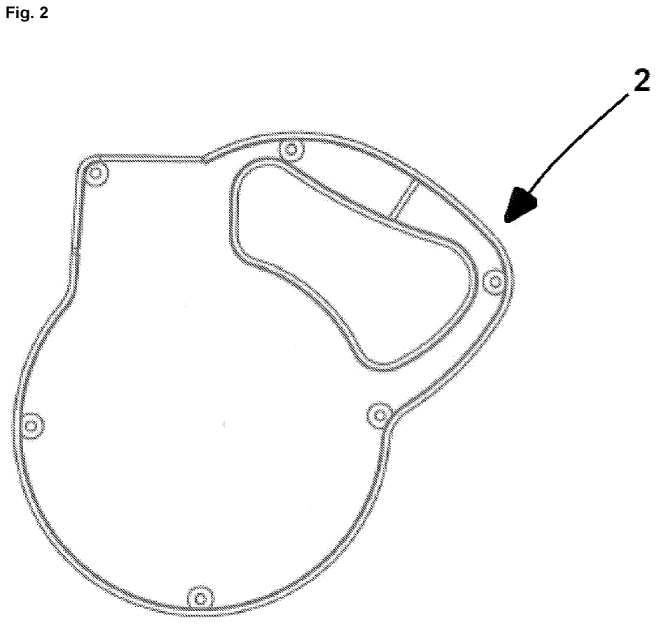

FIG. 2 is a side view of the handle housing 2 of the inventive animal walking device 1 according to FIG. 1. For the purpose of weight reduction, the handle housing 2 preferably consists of two housing shells screwed together which are preferably made of plastic material, in particular acrylonitrile-butadiene-styrene copolymer (ABS), a thermoplastic belonging to the group of engineering plastics. This has the advantage that an inventive animal walking device 1 which has been soiled by sand or dirt may easily be unscrewed and cleaned.

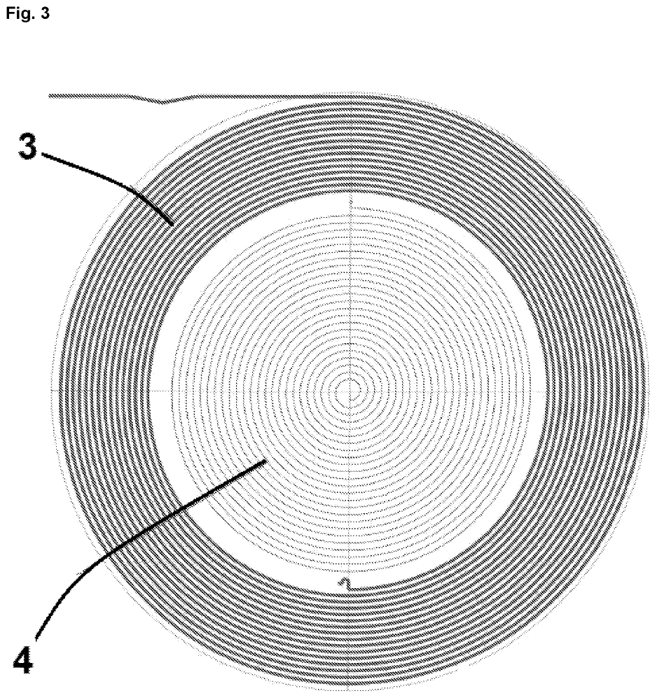

FIG. 3 is a detail view of the leash 3 and scroll spring 4 of the inventive animal walking device 1 according to FIG. 1. The leash 3 is preferably configured as a ribbon or strap and its dimensions are preferably 15 mm×1.5 mm. Preferably, the leash 3 is made of durable and/or weather-resistant nylon fabric. The scroll spring 4, which preferably has the dimensions 14 mm×0.5 mm, preferably consists of a light-weight, flexible spring steel.

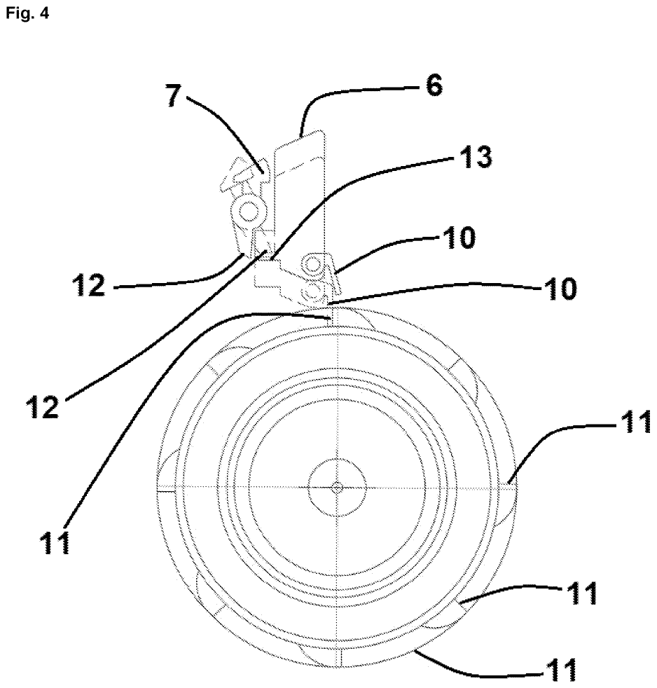

FIG. 4 is a side view of the break mechanism of the inventive animal walking device 1 according to FIG. 1. By pressing down the braking knob 6, said braking knob 6 is moved from its release position shown with a solid line to a breaking position or stop position shown with a dashed line. The winding and unwinding movements of the non-illustrated leash 3 may thus be decelerated or stopped by pressing down the braking knob 6 since this operatively connects a brake 10 arranged on the lower end of the braking knob 6 with contact surfaces 11 arranged on the drum 5. In order to lock the braking knob 6 in the position shown with a dashed line, the locking knob 7 is moved from a release position shown with a solid line to a locking position shown with a dashed line, whereby a lower end 12 thereof is brought into operative connection with a contact surface 13 arranged on the braking knob 6.

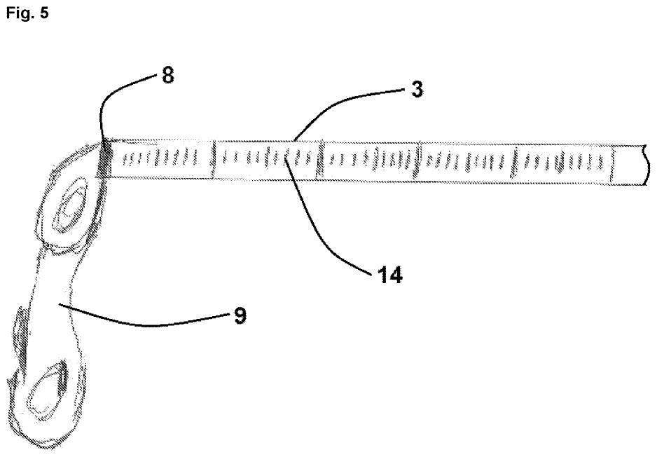

FIG. 5 is a portion of a leash 3 of an inventive animal walking device. The leash 3 has a measuring scale 14 which extends at least over a part of the length of the leash 3 thus making it possible to measure a distance. In FIG. 5 and in the preceding Figures in which a leash 3 is shown and said leash 3 has at least one non-illustrated measuring scale 14, which may preferably be least one linear measuring scale, at least one measuring scale 14 of the inventive animal walking device is arranged on the leash 3 and on the attachment device 9. For reasons of greater clarity, in FIG. 5 and in the preceding Figures in which an attachment device 9 is shown, the representation of the measuring scale 14 on the attachment device 9 has been omitted. As an alternative, at least one measuring scale 14 is arranged on the leash 3 and on the collar fixedly arranged on said leash 3. The leash 3 of the inventive animal walking device may have a fixed length, so that the inventive animal walking device is not a retractable leash, or may include a retractable leash, in particular a retractable leash according to FIG. 1. Preferably, at least one measuring scale 14 having common units of measurement (e.g. a metre unit, an inch unit and/or a foot unit) is arranged on the leash 3, preferably by printing on, e.g., the nylon fabric of leash 3.

The inventive animal walking device is an animal device which functions as a measuring tape. Preferably, the inventive animal walking device has an automatically retractable leash which can function as a measuring tape. Regardless of whether a leash with a fixed length or a retractable leash is used, the inventive animal walking device has the advantage that the user will always have a measuring tape at hand and does not have to look for a folding rule or a metre rule when a distance between a point A and a point B needs to be measured. Every-day situations in which a distance between a point A and a point B needs to be measured, such as, for example, measuring the width of a new dog collar for the growing dog, making measurements to document a child's growth spurt, measuring the dimensions of a piece of furniture, measuring the distance separating the user from the animal being walked or measuring any other distance, are thus easily mastered. When a distance between a point A and a point B needs to be measured, the user may also, in accordance with the invention, rely on the animal being walked as an aid for fulfilling such a measurement job.

All of the characteristics represented in the description, in the following claims and in the drawings, as considered either in themselves or in any combination with each other, may be deemed essential to the invention.

### LIST OF REFERENCE NUMERALS

1 animal walking device
2 handle housing
3 leash
4 scroll spring
5 drum
6 braking knob
7 locking knob
8 attachment point
9 attachment device
10 brake
11 contact surface
12 lower end
13 contact surface
14 measuring scale

1. An animal walking device (1),
including at least one leash (3),
including at least one attachment device that is arranged on the leash (3) at an attachment point (9) and serves for attaching said leash (3) onto a collar worn by an animal being walked or onto a harness worn by an animal being walked, or including a collar for an animal being walked which is fixedly arranged on the leash (3),
characterised in that
the animal walking device (1) has at least one measuring scale (14), wherein at least one measuring scale (14) is arranged on the leash (3) and on the attachment device (9), or at least one measuring scale (14) is arranged on the leash (3) and on the collar fixedly arranged on the leash (3).

2. The animal walking device (1) as claimed in claim 1, characterised in that
at least one other measuring scale (14) is arranged on the leash (3) and/or on the attachment device (9), or at least one other measuring scale (14) is arranged on the leash (3) and/or on the collar fixedly arranged on the leash (3).

3. The animal walking device (1) as claimed in claim 1-of
characterised in that the zero point of the measuring scale (14) is arranged on the leash (3), on the attachment device (9), or on the collar fixedly arranged on said leash (3).

4. The animal walking device (1) as claimed in claim 1,
characterised in that
at least one leash (3) is at least partially a ribbon, at least partially a strap and/or at least partially a cable.

5. The animal walking device (1) as claimed in claim 1,
characterised in that
at least one leash (3) is at least partially a ribbon, at least partially a strap and/or at least partially a cable.

6. The animal walking device (1) as claimed in claim 1,
characterised in that
the attachment device (9) is a hook, a spring hook, or an eyelet.

7. The animal walking device (1) as claimed in claim 1,
characterised in that
at least one measuring scale (14) has a metre measurement unit, an inch measurement unit and/or a foot measurement unit.

8. The animal walking device (1) as claimed in claim 1,
characterised in that
the animal walking device (1) has at least one pocket calculator, at least one pen holder and/or at least one notepad holder.

9. A method for determining a distance between a point A and a point B,
wherein a measuring scale (14) is used for measuring said distance,
characterised in that
an animal walking device (1) is employed for determining a distance, wherein the employed animal walking device (1) has at least one leash (3) and at least one attachment device (9) that is arranged on the leash (3) at an attachment point (8) and serves for attaching said leash (3) onto a collar worn by an animal being walked or onto a harness worn by an animal being walked, or wherein the animal walking device has a collar for an animal being walked which is fixedly arranged on the leash (3), and wherein the inventive animal walking device (1) has at least one measuring scale (14) by means of which a distance may be determined by a user, wherein at least one measuring scale (14) is arranged on the leash (3) and on the attachment device (9) or at least one measuring scale (14) is arranged on the leash (3) and on the collar that is fixedly arranged on the leash (3).

10. The method as claimed in claim 9,
characterised in that
the employed animal walking device (1) for distance determination is at least temporarily attached to the animal being walked.

11. The method as claimed in claim 10,
characterised in that
at the time of distance determination, the measuring scale (14) is positioned at point A by the user and at point B by the animal attached to the animal walking device (1).

12. The method as claimed in claim 11,
characterised in that
at the time of distance determination, the zero point of the measuring scale (14) is positioned at point A or at point B.

13. The method as claimed claim 9,
characterised in that
in a process step prior to the time of distance determination, the user moves towards point A and/or the animal attached to the animal walking device (1) moves towards point B.

14. The method as claimed in claim 13,
characterised in that
the path to be taken by the user when walking in the direction of point A leads via point B for enabling the positioning of the measuring scale (14) at point B by the animal attached to the animal walking device (1), and/or the path to be taken by the animal attached to the animal walking device (1) when walking towards point B leads via point A for enabling the positioning of the measuring scale (14) at point A by the user.

15. The method as claimed in claim 9,
characterised in that
the animal walking device (1) employed is an animal walking device (1) for a dog.

16. The method as claimed in claim 9,
characterised in that the animal walking device (1) employed is an animal walking device (1) as claimed in any one of claims 1 to 8.
